(19) United States
(12) Patent Application Publication
(10) Pub. No.: US 2025/0374092 A1
(43) Pub. Date: Dec. 4, 2025

(54) ENHANCED GAP MANAGEMENT FOR PACKET DATA CONVERGENCE PROTOCOL AND RADIO LINK CONTROL COUNT FOR WIRELESS COMMUNICATIONS

(71) Applicant: INTEL CORPORATION, Santa Clara, CA (US)

(72) Inventors: Yujian ZHANG, Beijing (CN); Marta MARTINEZ TARRADELL, Portland, OR (US); Rafia MALIK, Hillsboro, OR (US); Sudeep PALAT, Cheltenham (GB); Yi GUO, Shanghai (CN); Youn Hyoung HEO, Seoul (KR)

(73) Assignee: INTEL CORPORATION, Santa Clara, CA (US)

(21) Appl. No.: 18/872,968

(22) PCT Filed: Jul. 6, 2023
(86) PCT No.: PCT/US2023/026977

§ 371 Date: Dec. 9, 2024

Related U.S. Application Data
(60) Provisional application No. 63/359,150, filed on Jul. 7, 2022.

(51) Int. Cl. H04W 24/08; H04L 1/1607; H04W 28/06

(52) U.S. Cl. CPC H04W 24/08; H04L 1/1614; H04W 28/06

(57) ABSTRACT

This disclosure describes systems, methods, and devices for gap management for packet data convergence protocol and radio link control count. A device may encode a first subset of packets; encode a second subset of packets based on the first subset; allocate a count for the first subset and the second subset; detect that the second subset is not to be transmitted by the device or decoded by a second device; encode, based on detecting that the first subset is not to be transmitted by the device or decoded by the second device, an indication to be transmitted to the second device to instruct the second device to skip a gap in the count based on the second subset.

### CROSS-REFERENCE TO RELATED PATENT APPLICATION(S)

This application claims the benefit of U.S. Provisional Application No. 63/359,150, filed Jul. 7, 2022, the disclosure of which is incorporated herein by reference as if set forth in full.

### TECHNICAL FIELD

This disclosure generally relates to systems and methods for wireless communications and, more particularly, to gap management for packet data convergence protocol and radio link control count.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2A illustrates a video slice-based traffic model, in accordance with one or more example embodiments of the present disclosure.

FIG. 2B illustrates a group of picture-based traffic model, in accordance with one or more example embodiments of the present disclosure.

FIG. 3A illustrates a flow diagram of illustrative process for gap management for packet data convergence protocol and radio link control count, in accordance with one or more example embodiments of the present disclosure.

FIG. 3B illustrates a flow diagram of illustrative process for gap management for packet data convergence protocol and radio link control count, in accordance with one or more example embodiments of the present disclosure.

FIG. 4. illustrates a network, in accordance with one or more example embodiments of the present disclosure.

FIG. 5 schematically illustrates a wireless network, in accordance with one or more example embodiments of the present disclosure.

FIG. 6 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for extended reality (XR, defined in Release 16 TR 26.928, Release 17 TR 38.838, Release 17 TR 26.926, and Release 18 TR 23.700-600, for example), and is being considered further in Release 18.

3GPP TR 26.928 defines XR as follows: “Extended reality (XR) refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).” XR may refer to equipment, applications and functions used for Virtual Reality, Augmented Reality, and other related technologies.

Some XR applications cannot decode certain packets if related packets are lost or corrupted. For example, a video frame may require a correct decoding of the I-frame (intra-coded frame) to enable the decoding of the sub-sequent P-frames (predicted frames). Therefore, their transmission over an air interface might be unnecessary.

Similar examples can also be explained based on the new term used by 3GPP, “PDU set,” (protocol data unit—PDU), however, this may also apply in other cases when PDUs are inter-related. For simplicity, the term “PDU set” is used herein, but other types of related transmissions may apply in addition to PDUs. Multiple scenarios are provided herein in which packets within a “PDU set” (i.e. intra PDU set scenario) or related “PDU sets” (i.e. inter PDU set scenario) may be discarded when there is a problem with a packet within the “PDU set” for intra scenario, or with the “PDU set” that is required (and on which other PDU sets depend). However, from a RAN handling's perspective, there might not be much difference between both options (i.e. intra PDU set and inter PDU set). For example, if a subset of PDCP PDUs (subset X) cannot be delivered or decoded, a gNB (or UE) drops another subset of PDCP PDUs (subset Y).

3GPP currently defines the packet data convergence protocol (PDCP) operations. A transmitting PDCP entity maintains a discardTimer configured for data radio bearers (DRBs), such as in the range of 0.5 milliseconds, 1 millisecond, 2 milliseconds, 4 milliseconds, up to 1.5 seconds and infinity. In the transmitter, a new timer is started upon reception of a SDU from the upper layer of the transmitting device. When the discardTimer expires for a PDCP SDU, the transmitting PDCP entity discards the PDCP SDU along with the corresponding data PDU. When the corresponding PDCP data PDU has been submitted to lower layers of the entity, the discard may be indicated to the lower layers.

Discarding a PDCP SDU already associated with a PDCP sequence number (SN) causes a SN gap in the transmitted PDCP data PDUs, increasing PDCP reordering delay on the receiving entity, so the UE implementation may determine how to minimize the SN gap after SDU discarding. The receiving entity maintains a t-Reordering timer used to detect loss of PDCP data PDUs (e.g., in the range of 0 milliseconds, 1 millisecond, up to 3 milliseconds). If t-Reordering is running, it shall not be started additionally (e.g., only one t-Reordering timer per receiving PDCP entity running at a given time). When the t-Reordering timer expires, the receiving PDCP entity delivers to its upper layers in ascending order of the associated COUNT value after performing header decompression, if not before: (1) all stored PDCP SDUs with associated COUNT value<RX_REORD, and (1) all stored PDCP SDUs with consecutively associated COUNT values starting from RX_REORD. The receiving PDCP entity also may update RX_DELIV to the COUNT value of the first PDCP SDU not delivered to upper layers, with COUNT value≥RX_REORD. When RX_DELIV<RX_NEXT, update RX_REORD to RX_NEXT, and start t-Reordering.

Previously, the SN gap due to lost or corrupted transmission packets was a somewhat rare problem for the receiving entity. However, with the increased use of sets of related transmissions, including PDU sets, the SN gap may become a larger issue for the receiving entity. The present disclosure provides techniques for managing this issue.

In one or more embodiments, the present disclosure efficiently supports the skipping of one or more transmissions (e.g., PDCP PDUs, RLC PDUs, etc.), allowing a transmission gap on the transmission count, and avoiding unnecessary transmissions over an air interface. As a result, capacity may be improved, and devices may save power. The transmitter side may inform the receiver side of the skip in the COUNT to reduce the associated delay on the receiver side.

In the present disclosure, the following definitions may be used:

PDU Set: A PDU Set is composed of one or more PDUs carrying the payload of one unit of information generated at the application level (e.g. a frame or video slice for XRM Services, as used in TR 26.926). In some implementations all PDUs in a PDU Set are needed by the application layer to use the corresponding unit of information. In other implementations, the application layer can still recover parts all or of the information unit, when some PDUs are missing.

Multi-modal Data: Multi-modal Data is defined to describe the input data from different kinds of devices/sensors or the output data to different kinds of destinations (e.g. one or more UEs) required for the same task or application. Multi-modal Data consists of more than one Single-modal Data, and there is strong dependency among each Single-modal Data. Single-modal Data can be seen as one type of data (e.g., see TR 22.847).

Data Burst: A set of multiple PDUs generated and sent by the application in a short period of time. A Data Burst can be composed by one or multiple PDU Sets.

Release 17 TR 38.838 describes how video traffic may be modeled. One option is to use slice-based traffic in which a single video frame is divided into N slices. N (one I and N-1 P) packets correspond(s) to one video frame arriving at a same time, somewhat like intra-frame encoding. Table 1 below shows an example of the slice-based traffic model.

TABLE 1
Slice-Based Traffic

| Packet | SN (#) | Stream/priority | Dependency | . . . |
|---|---|---|---|---|
| A | 1 | 1 | — | |
| B | 2 | 2 | 1 | |
| | . . . | . . . | . . . | . . . |
| C | N | 2 | 1 | |
| D | N + 1 | 1 | — | |
| E | N + 2 | 2 | N + 1 | |
| | . . . | . . . | . . . | . . . |
| F | N + N | 2 | N + 1 | |
| | . . . | . . . | . . . | . . . |

Another option is to use a group-of-picture (GOP)-based traffic model in which a single video frame is either I frame or P frame. An I frame is transmitted every K frames, where K is the GOP size, i.e., every GOP. One video frame arrives at a time as a packet. This option is somewhat like inter-frame encoding. Table 2 below shows an example of the GOP-based traffic model.

TABLE 2
GOP-Based Traffic

| Packet | SN (#) | Stream/priority | Dependency | . . . |
|---|---|---|---|---|
| A | 1 | 1 | — | |
| B | 2 | 2 | 1 | |
| | . . . | . . . | . . . | . . . |
| C | K | 2 | 1 | |
| D | K + 1 | 1 | — | |
| E | K + 2 | 2 | K + 1 | |
| | . . . | . . . | . . . | . . . |
| F | K + K | 2 | K + 1 | |
| | . . . | . . . | . . . | . . . |

From the RAN's handling perspective, there might not be much difference between option (1), i.e. intra PDU set, and (2), i.e. inter PDU set. Therefore, from the 3GPP point of view, these video traffic models could be handled in an abstract manner, for example, packets with their own SN may be part of same or different PDU set belong to same or different stream/priority and with some relation/dependency between them. Another example focusing on whether packets may be dropped or skipped, from the gNB's perspective, is that if a subset of PDCP PDUs (e.g., subset X) cannot be delivered, the gNB may be allowed to drop another subset of PDCP PDUs (e.g., subset Y). Some solutions focus on methods to efficiently support the skip or gap of the PDCP COUNT or RLC COUNT.

In one or more embodiments, the solutions herein may apply to the uplink and downlink sides. Assuming the DL scenario where a subset of PDCP PDUs (e.g., subset X) cannot be delivered or decoded or is not useful, a gNB drops another subset of PDCP PDUs (e.g., subset Y). What impact in Uu is that if one or more PDCP PDUs in subset Y has been transmitted in Uu (no matter UE has received or not), since gNB has already allocated PDCP COUNT for those PDUs, gNB cannot reuse those COUNT due to security concerns. The gNB needs to inform the UE to update its state variable (mainly RX_DELIV, and possibly RX_NEXT due to constraint of RX_NEXT>RX_DELIV) to move past those PDUs that cannot be received. Therefore, the gNB informs the UE of the gap of PDCP COUNT to skip instead of relying on the expiry of t-Reordering timer.

There are two types of PDUs that can be categorized as not useful: (1) PDUs that have not been transmitted in air interface yet. For those PDUs, the transmitter can drop them without informing the receiver. In this case, the PDCP COUNT can be reused. (2) PDUs that have been transmitted in air interface, but not received. PDCP COUNT cannot be reused. For those PDUs, the transmitter can drop them, but need to inform the receiver. It is easier to differentiate between case (1) and (2) on the UE Tx side than on the gNB side when CU (centralized unit—supporting upper layers of the communication stack, such as SDAP, PDCP, and radio resource control) and DU (distributed unit—supporting lower layers of the communication stack, such as radio link control, medium access control, and physical layer) are split.

For CU/DU split, a CU may drop relevant PDCP PDUs that have been transformed to a DU. If so, the F1-U protocol may need to be enhanced for the gNB-CU-UP to inform a gNB-DU on which subset of PDCP PDUs to drop. Therefore, similar kinds of information may be exchanged between Tx side and Rx side and may also be exchanged between gNB-CU-UP to inform a gNB-DU. Alternatively, this handling may be based on gNB implementation.

This mechanism of a gNB informing the UE of the gap in PDCP COUNT may be triggered by other means. For XR kind of traffic, the transmitter (Tx) side may determine the Y packets to drop based on information provided by receiver (Rx) side or by an application. For example, if the subset X of PDCP PDUs that is critical are not received successfully by the Rx side, the Rx side can inform to the Tx side to trigger the skip of the related subset Y of PDCP PDUs. Another example may be when an application (in Tx or Rx side) is the one which have the information on whether inter-related packets can or cannot be skipped when there is a problem with the critical ones (here referred as subset X); for this example, the application (in Tx or Rx side) can inform the AS layer or the other side.

When some PDCP PDUs are not useful due to the loss of associated PDCP PDUs, and the corresponding packets (e.g. PDCP PDUs, RLC SDUs or segments have not been submitted to MAC layers), the UE or gNB may be allowed to drop or skip them i.e., those packets are not conveyed over the air. This may be applied to packets sent in either direction i.e., by gNB for downlink packet or by UE for uplink packets.

For notification of the packets to be dropped or skipped, considering that the DRB might be used to multiplex different services, a more general approach is that gNB (or UE) may provide a list of PDCP COUNTs that a UE (or gNB) should consider received. The signaling for such list can be different options: (1) Similar to PDCP status report, for example with a start COUNT and a bitmap as shown in Table 3 below:

TABLE 3
PDCP Control PDU Format for PDCP
Gap Information Using Option (1)

| | | | | | | |
|---|---|---|---|---|---|---|
| D/C | PDU Type | R | R | R | R | Octet 1 |

| | |
|---|---|
| FDC | Octet 2 |
| FDC (Continued) | Octet 3 |
| FDC (Continued) | Octet 4 |
| FDC (Continued) | Octet 5 |
| Bitmap 1 (Optional) | Octet 6 |
| . . . | . . . |
| Bitmap N (Optional) | Octet 5 + N |

Referring to Table 3, FDC refers to First Dropped COUNT (length of 32 bits), and the FDC field indicates the COUNT value of the first dropped PDCP SDU within the recording window (e.g., RX_DELIV). The bitmap length may be variable (and can be 0), and indicates which SDUs are dropped and not dropped by the transmitting PDCP entity. The bit position of the Nth bit in the bitmap may be N (e.g., the bit position of the first bit in the bitmap is 1). Table 4 below shows an example bitmap.

TABLE 4
Bitmap

| Bit | Description |
|---|---|
| 0 | PDCP SDU with COUNT = (FDC + bit position) modulo 2³² is |
| | dropped. |
| 1 | PDCP SDU with COUNT = (FDC + bit position) modulo 2³² is |
| | not dropped. |

Option (2): Similar to RLC status report kind of notification but to be used in PDCP level for the update of the COUNT, for example with a list of pairs of start COUNT and end COUNT as shown below in Table 5:

TABLE 5
PDCP Control PDU Format for PDCP
Gap Information Using Option (2)

| | | | | | | |
|---|---|---|---|---|---|---|
| D/C | PDU Type | R | R | R | R | Octet 1 |

| FDC | | | Octet 2 |
|---|---|---|---|
| FDC (Continued) | | | Octet 3 |
| FDC (Continued) | | | Octet 4 |
| FDC (Continucd) | | | Octet 5 |
| Range | | | Octet 6 |
| | E | Offset | Octet 7 |

| | |
|---|---|
| Offset (Continued) | Octet 8 |
| Range | Octet 9 |
| . . . | . . . |

In Table 5, the E field refers to the Extension field, with a length of one bit. The E field indicates whether a set of offset and range fields follows the E field. The interpretation of the E field is provided below in Table 6.

TABLE 6
E Field Interpretation

| Value | Description |
|---|---|
| 0 | A set of Offset and Range does not follow. |
| 1 | A set of Offset and Range follows. |

The range field may be an 8-bit field defining the number of consecutively dropped PDCP PDUs starting from and including the corresponding FDC or offset. The offset field may be 15 bits in length and may indicate the COUNT value of the dropped PDCP SDU within a reordering window (e.g., RX_DELIV). Denote COUNT_PREV for the last PDCP PDU indicated by previous (FDC, Range) pair or (Offset, Range) pair, then the COUNT value indicated by current (Offset, Range) pair is COUNT_PREV+Offset.

Option (3): A new flag may be added in one of the reserved bits of the a PDCP PDU header at the Tx side to indicate to the Rx side that a PDCP SN not received until this one should be considered as skipped (dropped) by Rx side because they were discarded/skipped by the Tx side. Based on this information, the Rx side would update the COUNT and corresponding variables. This solution would be beneficial if the DRB in use only carries information of a single XR application/flow/stream. For example, Tables 7-9 below show how one of the fields of the PDCP header (marked with an F of Flag) to indicate that all the PDCP PDUs up to this one that were not received should be assumed as skipped or drop.

TABLE 7
Data PDU for DRBs and MRBs with 12 bits PDCP SN

| | | | | | |
|---|---|---|---|---|---|
| D/C | R | R | F | PDCP SN | Octet 1 |

| | |
|---|---|
| PDCP SN (Continued) | Octet 2 |
| Data | Octet 3 |
| . . . | . . . |
| MAC 1 (Optional) | Octet N − 3 |
| MAC 1 (Continued) (Optional) | Octet N − 2 |
| MAC 1 (Continued) (Optional) | Octet N − 1 |
| MAC 1 (Continued) (Optional) | Octet N |

The format of a PDCP data PDU in Table 7 is applicable for UM DRBs, AM DRBs, UM MRBs, and AM MRBs.

TABLE 8
Data PDU for DRBs and MRBs with 18 bits PDCP SN

| | | | | | | | |
|---|---|---|---|---|---|---|---|
| D/C | R | R | R | R | F | PDCP SN | Octet 1 |

| | |
|---|---|
| PDCP SN (Continued) | Octet 2 |
| PDCP SN (Continued) | Octet 3 |
| Data | Octet 4 |
| . . . | . . . |
| MAC 1 (Optional) | Octet N-3 |
| MAC 1 (Continued) (Optional) | Octet N-2 |
| MAC 1 (Continued) (Optional) | Octet N-1 |
| MAC 1 (Continued) (Optional) | Octet N |

The format of a PDCP data PDU in Table 8 is applicable for UM DRBs, AM DRBs, UM MRBs, and AM MRBs.

Table 9 shows a Data PDU for SRBs (e.g., with 12 bits PDCP SN).

TABLE 9
PDCP Data PDU Format for SRBs

| | | | | | |
|---|---|---|---|---|---|
| R | R | R | F | PDCP SN | Octet 1 |

| | |
|---|---|
| PDCP SN (Continued) | Octet 2 |
| Data | Octet 3 |
| . . . | . . . |
| MAC 1 | Octet N − 3 |
| MAC 1 (Continued) (Optional) | Octet N − 2 |
| MAC 1 (Continued) (Optional) | Octet N − 1 |
| MAC 1 (Continued) (Optional) | Octet N |

Data PDUs for SRBs may not be required if there are no use cases identified where XR traffic is conveyed over a SRB.

The new information shared between the Tx side and the Rx side may be added as an extension within a current PDCP status report. However, the triggering events may be different, so it may be preferable to define them as part of a new PDCP Ctrl PDU as defined in Options (1) and (2).

For the receiver side operation when receiving PDCP gap information, when a PDCP gap information is received, the receiving PDCP entity may: for each PDCP PDU indicated as dropped, perform the operation of updating PDCP state variables (RX_DELIV, RX_NEXT) and handling of timer t-Reordering above as if the PDCP PDU is received from lower layers. Similar enhancements can be used in UL. UL action in UE might be tied to the expiry of the PDCP discard timer.

Regarding a RLC entity for a PDCP control PDU carrying PDCP gap information, PDCP control PDU carrying PDCP gap information can be transmitted in a primary RLC entity, as in an existing 3GPP operation. Alternatively, a dedicated RLC entity/bearer can be configured by RRC signaling so that PDCP control PDU carrying PDCP gap information is transmitted in the dedicated RLC entity/bearer. The dedicated RLC entity is not used to carry PDCP data PDUs, and it can be either RLC AM or RLC UM entity. Using a dedicated RLC entity for PDCP control PDU has the benefit that the 1:1 relationship between PDCP PDU and a RLC SDU in Option A (Implicit Approach) of Solution (2) below can be maintained.

Solution (2): Enhancements to support skip or gap in the RLC SN. If RLC AM is used, similar to PDCP, a gNB needs to inform a UE about the RLC SNs that the UE should consider as received. RLC AM needs such an enhancement more than PDCP because the PDCP eventually relies on timer expiry (e.g., PDCP assumes that packet loss can happen in a lower layer), while RLC AM will always try to deliver all packets successfully, and a receiver window will not move until packet is successfully received. The above could be applicable for the option of using one DRB or multiple DRBs. There are several options of indicating the RLC SNs dropped: (A) There is 1:1 relationship between PDCP PDU and a RLC SDU. In typical cases, once the receiver knows the relationship between a PDCP COUNT and RLC SN, the UE can derive the PDCP COUNT based on RLC SN, or vice versa, with the limit of RLC SN wrap around. For example, if UE knows that the PDCP COUNT 5 corresponds to the RLC SN 10, then UE knows that PDCP COUNT 6 corresponds to RLC SN 11, and so on. Therefore, based on the PDCP gap information, the receiver can derive which RLC SDUs are dropped.

There are several sub-options for an implicit approach: (A1) in this sub-option, no additional information is provided other than the PDCP gap information. When receiver receives PDCP gap information, it derives the RLC SNs for the RLC SDUs that are considered dropped by using the relationship of PDCP COUNT and RLC SN of previously received RLC SDU, e.g. based on the PDCP COUNT which is closest to First Dropped COUNT (FDC) in PDCP gap information. (A2) A RLC SN is explicitly indicated in the PDCP gap information. For example, RLC SN corresponding to First Dropped COUNT (FDC) is indicated in PDCP gap information. The receiver then derives the RLC SNs for the RLC SDUs that are considered dropped by using FDC and the provided RLC SN.

Option (B): RLC SNs for the dropped RLC SDUs are explicitly indicated. There are two sub-options: (B1) a combination of First Dropped Sequence Number (FDCN) and bitmap is indicated, with an example RLC Control PDU format shown below in Table 10.
a combination of First Dropped Sequence Number (FDCN) and bitmap is indicated, with an example RLC Control PDU format shown below in Table 10:

TABLE 10
RLC Control PDU Format for RLC Gap Information (Option B1)

| | | | | | |
|---|---|---|---|---|---|
| D/C | CPT | R | R | PDCP SN | Octet 1 |

| | |
|---|---|
| FDSN | Octet 2 |
| FDSN | Octet 3 |
| Bitmap 1 | Octet 4 |
| Bitmap 2 | Octet 5 |
| . . . | . . . |
| Bitmap N | Octet N + 3 |

In Table 10, an 18-bit RLC SN is used as an example (e.g., sn-FieldLength=18), and the solution is applicable to other RLC SN lengths (e.g., 12 bits). The FDCN refers to the first dropped sequence number (length of 18 bits), indicating the RLC SN of the first dropped RLC SDU. The bitmap length is variable and can be 0, and indicates which RCL SDUs are dropped and not in the RLC entity. The bit position of the Nth bit in the bitmap in N (e.g., the bit position of the first bit in the bitmap is 1). Table 11 shows the bitmap format.

TABLE 11
Bitmap

| Bit | Description |
|---|---|
| 0 | RLC SDU with SN = (FDSN + bit position) modulo 2^{[sn-FieldLength]} is |
| | dropped. |
| 1 | RLC SDU with SN = (FDSN + bit position) modulo 2^{[sn-FieldLength]} is |
| | not dropped. |

Option (B2): a list of pairs of start RLC SN and end RLC SN is indicated, with an example RLC Control PDU format shown below in Table 12.

TABLE 12
RLC Control PDU Format for RLC Gap Information (Option B2)

| | | | | | |
|---|---|---|---|---|---|
| D/C | CPT | R | E | FDSN | Octet 1 |

| FDSN | | | Octet 2 |
|---|---|---|---|
| FDSN | | | Octet 3 |
| Range | | | Octet 4 |
| | E | Offset | Octet 5 |

| | |
|---|---|
| Offset | Octet 6 |
| . . . | . . . |

In Table 12, a 18 bit RLC SN is used as an example, i.e sn-FieldLength=18. The solution is applicable to other length of RLC SN, e.g. 12 bits. First Dropped Sequence Number (FDCN). Length: 18 bits. This field indicates the RLC SN of the first dropped RLC SDU. Extension (E) field: Length: bit. The E field indicates whether a set of Offset and Range follows. The interpretation of the E field is provided in Table 13 below.

TABLE 13
E Field Interpretation

| Value | Description |
|---|---|
| 0 | A set of Offset and Range does not follow. |
| 1 | A set of Offset and Range follows. |

Range field: Length: 8 bits. This Range field is the number of consecutively dropped RLC SDUs starting from and including corresponding FDSN or Offset. Offset field: Length: 15 bits. This field indicates the RLC SN value of the dropped RLC SDU. Denote SN_PREV for the last RLC SDU indicated by previous (FDSN, Range) pair or (Offset, Range) pair, then the RLC SN value indicated by current (Offset, Range) pair is (SN_PREV+Offset) modulo 2^{[sn-FieldLength]}

When RLC gap information is received, the receiving side of the RLC entity may: for each RLC SDU indicated as dropped, perform the operation of updating RLC state variables and start/stop t-Reassembly as needed as if the RLC PDU is received from lower layers.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

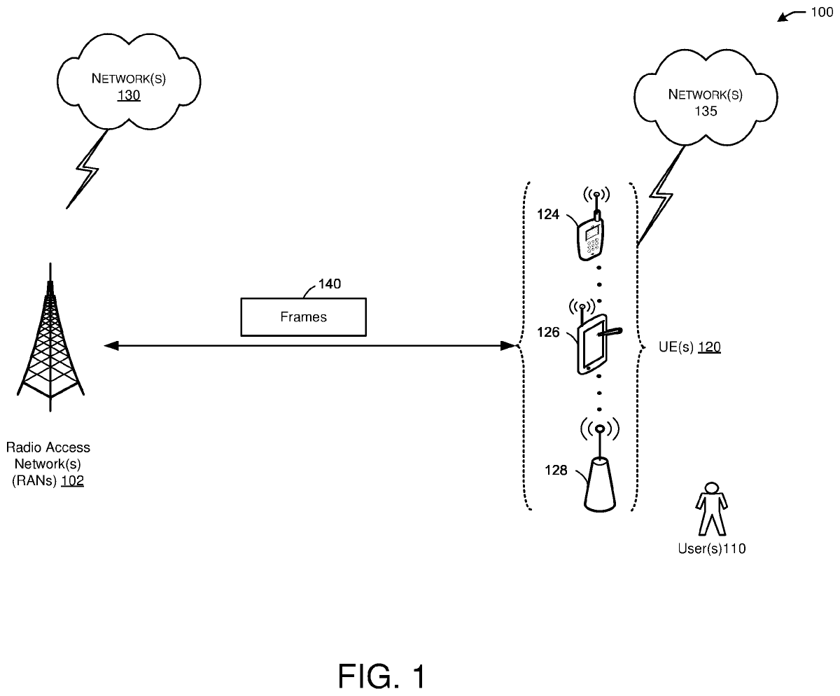

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

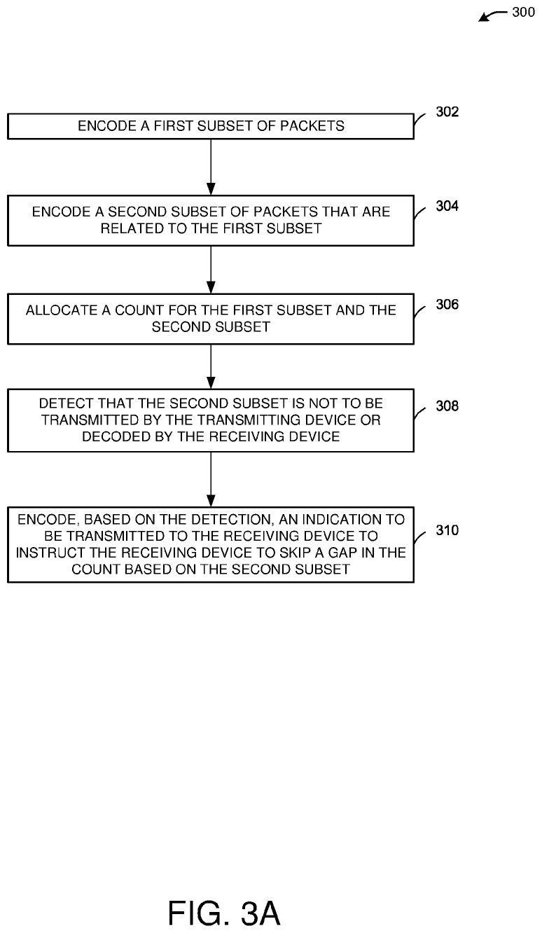

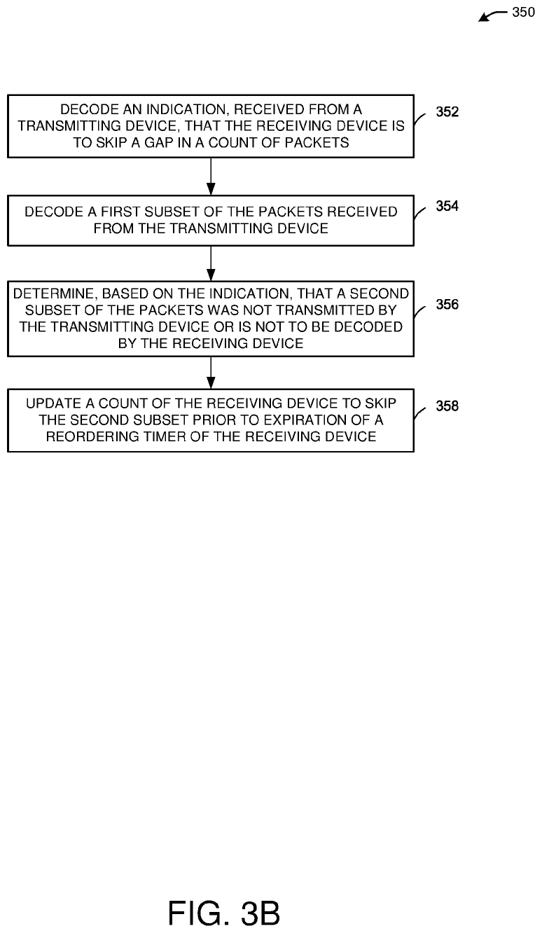

In some embodiments, the UEs 120 and the RANs 102 may include one or more computer systems similar to that of FIGS. 3-5.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UE 120 may exchange frames 140 with the RANs 102. The frames 140 may include video frames and slices (e.g., used in XR). The frames 140 also may include other types of frames and signaling that a transmitting device did not transmit a subset of frames related to other transmitted frames, or that a receiving device is not to decode the subset of related frames.

It is understood that the above descriptions are for purposes of illustration and are not meant to be limiting.

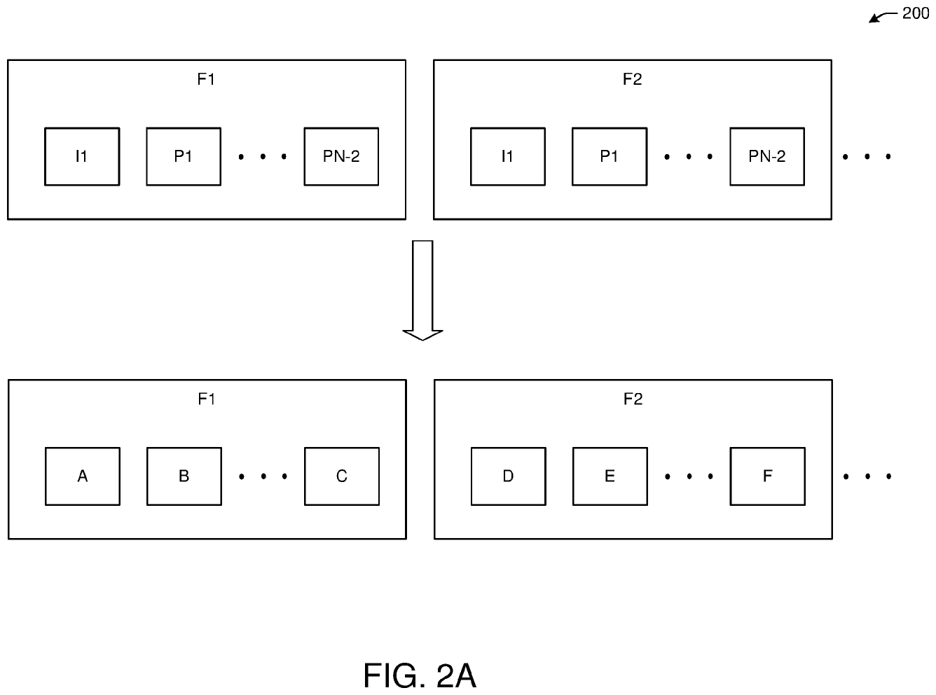

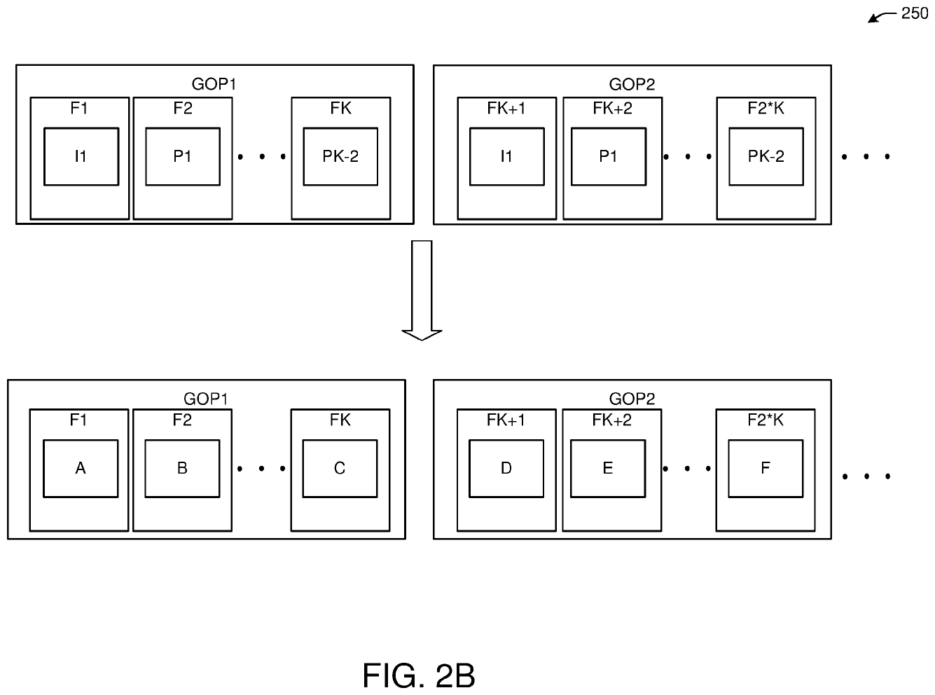

FIG. 2A illustrates a video slice-based traffic model 200, in accordance with one or more example embodiments of the present disclosure.

Referring to FIG. 2A, the slice-based traffic model 200 shows a single video frame (e.g. F1, F2, etc.) divided into N slices or packets (e.g., F1 with i-frame I1 and P1-PN-2 packets/slices, F2 with i-frame I1 and P1-PN-2 packets/slices). The slice-based traffic model 200 may be abstract so that frame F1 may include packets A, B, . . . , C, frame F2 may include packets D, E, . . . F, and so on. The packets, sequence number, stream/priority, and their dependencies are shown in Table 1 above as an example of packets with dependencies, therefore applicable to the gap management described herein.

FIG. 2B illustrates a group of picture-based traffic model 250, in accordance with one or more example embodiments of the present disclosure.

Referring to FIG. 2B, the GOP-based traffic model 250 shows single video frames as either i-frames (e.g., I1) or p-frames (e.g., P1, . . . , PK-2) in which an i-frame is transmitted every K frames, where K is the size of a GOP (e.g., GOP 1, GOP2, etc.). One video frame arrives at a time as a packet. The frames may be abstract as GOP1 including frame F1 as packet A, frame F2 as packet B, . . . , frame FK as packet C, and as GOP2 including frame FK+1 as packet D, frame FK+2 as packet E, and frame F2*K as packet F. The packets, sequence number, stream/priority, and their dependencies are shown in Table 2 above as an example of packets with dependencies, therefore applicable to the gap management described herein.

Referring to FIGS. 2A and 2B, the frames may be sent in the frames 140 of FIG. 1. Looking at the above analysis, from a RAN's handling perspective, there might not be much difference between FIG. 2A and FIG. 2B. Therefore, from a 3GPP point of view, these video traffic models could be handled in an abstract manner, for example, a packet with their own SN, which may be part of same or different PDU set belong to same or different stream/priority and with some relation/dependency between them. Another example focusing on whether packets may be dropped or skipped, from a gNB's perspective is that if a subset of PDCP PDUs (subset X) cannot be delivered, the gNB may be allowed to drop another subset of PDCP PDUs (subset Y).

FIG. 3A illustrates a flow diagram of illustrative process 300 for gap management for packet data convergence protocol and radio link control count, in accordance with one or more example embodiments of the present disclosure.

At block 302, a device (e.g., the RAN 102 or the UEs 120 of FIG. 1) may encode a first subset of packets to be transmitted to a second device.

At block 304, the device may encode a second subset of the packets, the second subset being related to the first subset.

At block 306, the device may allocate a count for the first subset and the second subset.

At block 308, the device may detect that the second subset is not to be transmitted by the device, or that the second subset has been transmitted, but is not to be decoded by the second device.

At block 310, the device may encode, based on the detection, an indication to be transmitted to the second device to instruct the second device to skip a gap in the count based on the second subset.

FIG. 3B illustrates a flow diagram of illustrative process 350 for gap management for packet data convergence protocol and radio link control count, in accordance with one or more example embodiments of the present disclosure.

At block 352, a device (e.g., the RAN 102 or the UEs 120 of FIG. 1) may decode an indication, received from a transmitting device, that the device is to skip a gap in a count of packets.

At block 354, the device may decode a first subset of the packets received from the transmitting device; At block 356, the device may determine, based on the indication, that a second subset of the packets was not transmitted by the transmitting device or is not to be decoded by the device.

At block 358, the device may update a count of the device to skip the second subset prior to expiration of a reordering timer of the device.

These embodiments are not meant to be limiting.

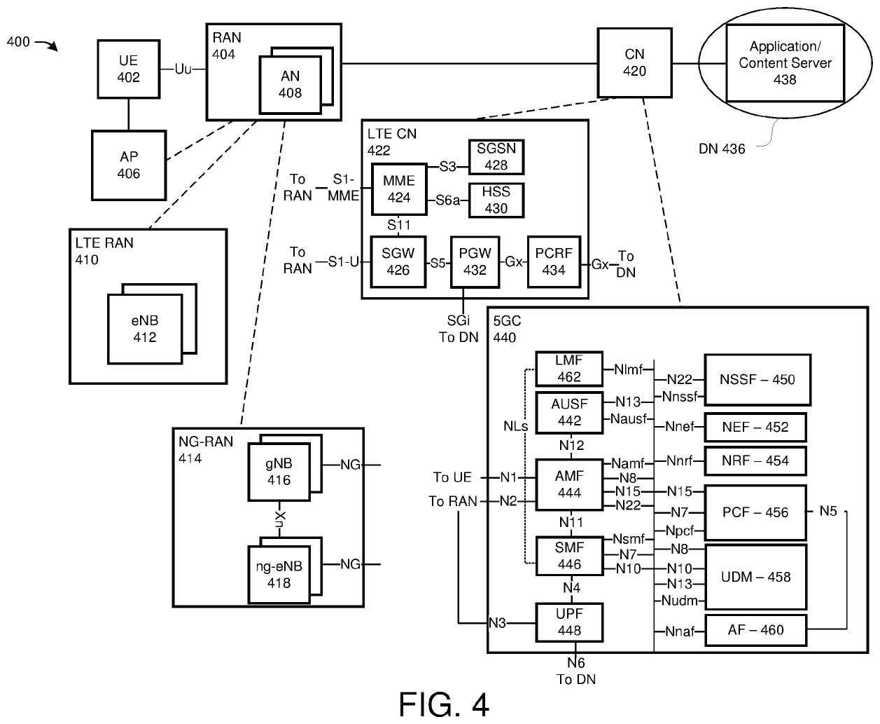

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and L1 protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an S1 interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network 436 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 432 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the UE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 450, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR 421 to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3^{rd} party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re)selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

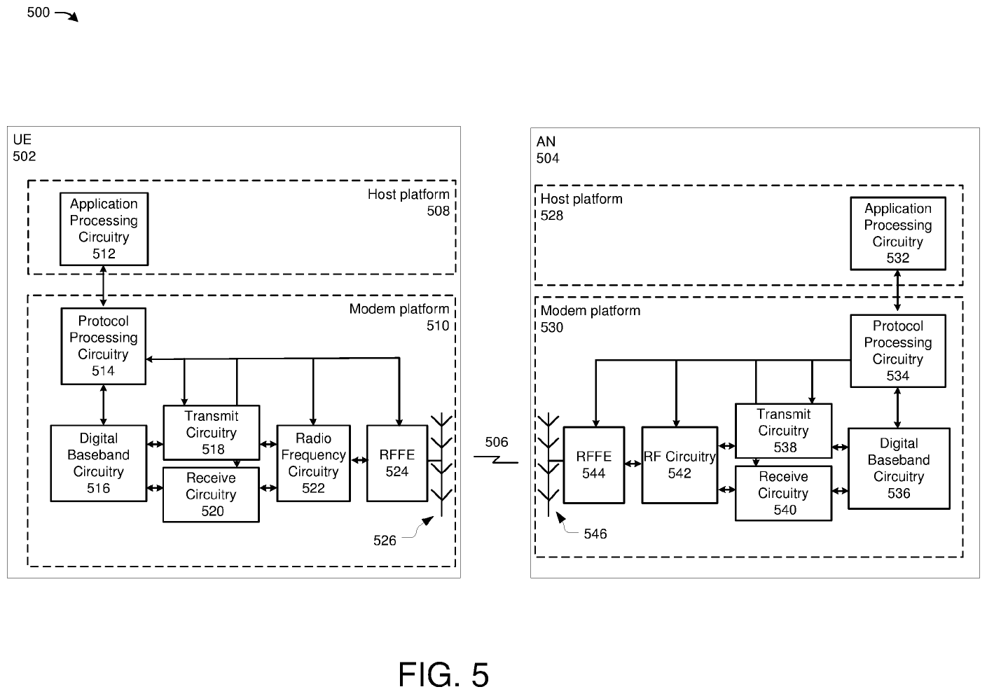

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHz frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

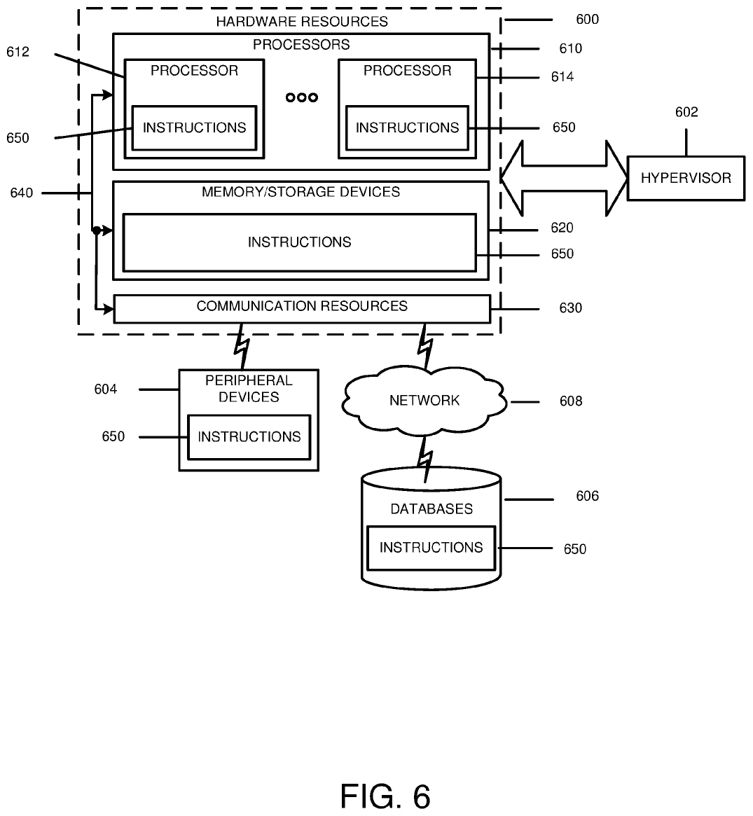

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include an apparatus of a device for gap management for packet data convergence protocol or radio link control count, the apparatus comprising processing circuitry coupled to storage for storing information associated with the gap management, the processing circuitry configured to: encode a first subset of packets; encode a second subset of packets based on the first subset; allocate a count for the first subset and the second subset; detect that the second subset is not to be transmitted by the device or decoded by a second device; encode, based on detecting that the first subset is not to be transmitted by the device or decoded by the second device, an indication to be transmitted to the second device to instruct the second device to skip a gap in the count based on the second subset.

Example 2 may include the apparatus of example 1 and/or any other example herein, wherein the first subset and the second subset comprise packet data convergence protocol (PDCP) data units.

Example 3 may include the apparatus of example 2 and/or any other example herein, wherein the processing circuitry is configured to detect that the second subset is based on the first subset.

Example 4 may include the apparatus of example 1 and/or any other example herein, wherein the processing circuitry is configured to identify a second information, received from the second device, that the second subset is based on the first subset.

Example 5 may include the apparatus of example 1 and/or any other example herein, wherein the device is a network nodeB (gNB).

Example 6 may include the apparatus of example 1 and/or any other example herein, wherein the device is a user equipment (UE).

Example 7 may include the apparatus of example 1 and/or any other example herein, wherein the count is a first dropped count (FDC), and wherein the indication comprises a bitmap.

Example 8 may include the apparatus of example 1 and/or any other example herein, wherein the indication comprises a list of pairs of a start count and an end count, an offset, and a range.

Example 9 may include the apparatus of example 1 and/or any other example herein, wherein the indication comprises a flag in a header of a PDCP data unit.

Example 10 may include the apparatus of example 1 and/or any other example herein, wherein the second subset comprises a radio link control (RLC) service data unit (SDU).

Example 11 may include the apparatus of example 10 and/or any other example herein, wherein the indication comprises a first dropped sequence number (FDSN) and a bitmap.

Example 12 may include the apparatus of example 1 and/or any other example herein, wherein the processing circuitry is further configured to discard the second subset prior to expiration of a discard timer of the device.

Example 13 may include a computer-readable storage medium comprising instructions to cause processing circuitry of a device for gap management of gap management for packet data convergence protocol or radio link control count, upon execution of the instructions by the processing circuitry, to: decode an indication, received from a first device, that the device is to skip a gap in a count of packets; decode a first subset of the packets, wherein the first subset is received from the first device; determine, based on the indication, that a second subset of the packets was not transmitted by the first device or is not to be decoded by the device; and update a count of the device to skip the second subset prior to expiration of a reordering timer of the device.

Example 14 may include the computer-readable medium of example 13 and/or any other example herein, wherein execution of the instructions further causes the processing circuitry to update a packet data convergence protocol (PDCP) state variable based on the indication.

Example 15 may include the computer-readable medium of example 13 and/or any other example herein, wherein the first subset and the second subset comprise packet data convergence protocol (PDCP) data units.

Example 16 may include the computer-readable medium of example 13 and/or any other example herein, wherein the device is a network nodeB (gNB).

Example 17 may include the computer-readable medium of example 13 and/or any other example herein, wherein the device is a user equipment (UE).

Example 18 may include the computer-readable medium of example 13 and/or any other example herein, wherein the indication comprises a bitmap.

Example 19 may include the computer-readable medium of example 13 and/or any other example herein, wherein the indication comprises a list of pairs of a start count and an end count, an offset, and a range.

Example 20 may include the computer-readable medium of example 13 and/or any other example herein, wherein the indication comprises a flag in a header of a PDCP data unit.

Example 21 may include the computer-readable medium of example 13 and/or any other example herein, wherein the second subset comprises a radio link control (RLC) service data unit (SDU).

Example 22 may include the computer-readable medium of example 13 and/or any other example herein, wherein the indication comprises a first dropped sequence number (FDSN) and a bitmap.

Example 23 may include a method for gap management of gap management for packet data convergence protocol or radio link control count, the method comprising: encoding, by processing circuitry of a first device, a first subset of packets; encoding, by the processing circuitry, a second subset of packets based on the first subset; allocating, by the processing circuitry, a count for the first subset and the second subset; detecting, by the processing circuitry, that the second subset is not to be transmitted by the first device or decoded by a second device; encoding, by the processing circuitry, based on detecting that the first subset is not to be transmitted by the first device or decoded by the second device, an indication to be transmitted to the second device to instruct the second device to skip a gap in the count based on the second subset.

Example 24 may include an apparatus including means for: encoding a first subset of packets; encoding a second subset of packets based on the first subset; allocating a count for the first subset and the second subset; detecting that the second subset is not to be transmitted by the device or decoded by a second device; encoding, based on detecting that the first subset is not to be transmitted by the device or decoded by the second device, an indication to be transmitted to the second device to instruct the second device to skip a gap in the count based on the second subset.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 14) may apply to the examples and embodiments discussed herein.

TABLE 14
Abbreviations

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource |
| | Indicator, CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance tableManagement Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control |
| | Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, Groupe |
| | Special Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| TETF | Internet Engineering Task Force |
| IF | Infrastructure |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IOT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |

Constraint length of the convolutional code, USIM Individual key

| | |
|---|---|
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single Frequency |
| | Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information |
| | Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame timing |
| | difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SIP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI- | Semi-Persistent CSI RNTI |
| RNTI | |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource Indicator, Synchronization |
| | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

What is claimed is:

1. An apparatus of a device for gap management for packet data convergence protocol or radio link control count, the apparatus comprising processing circuitry coupled to storage for storing information associated with the gap management, the processing circuitry configured to:
encode a first subset of packets;
encode a second subset of packets based on the first subset;
allocate a count for the first subset and the second subset;
detect that the second subset is not to be transmitted by the device or decoded by a second device; and
encode, based on detecting that the first subset is not to be transmitted by the device or decoded by the second device, an indication to be transmitted to the second device to instruct the second device to skip a gap in the count based on the second subset.

2. The apparatus of claim 1, wherein the first subset and the second subset comprise packet data convergence protocol (PDCP) data units.

3. The apparatus of claim 2, wherein the processing circuitry is configured to detect that the second subset is based on the first subset.

4. The apparatus of claim 1, wherein the processing circuitry is configured to identify a second information, received from the second device, that the second subset is based on the first subset.

5. The apparatus of claim 1, wherein the device is a network nodeB (gNB).

6. The apparatus of claim 1, wherein the device is a user equipment (UE).

7. The apparatus of claim 1, wherein the count is a first dropped count (FDC), and wherein the indication comprises a bitmap.

8. The apparatus of claim 1, wherein the indication comprises a list of pairs of a start count and an end count, an offset, and a range.

9. The apparatus of claim 1, wherein the indication comprises a flag in a header of a PDCP data unit.

10. The apparatus of claim 1, wherein the second subset comprises a radio link control (RLC) service data unit (SDU).

11. The apparatus of claim 10, wherein the indication comprises a first dropped sequence number (FDSN) and a bitmap.

12. The apparatus of claim 1, wherein the processing circuitry is further configured to discard the second subset prior to expiration of a discard timer of the device.

13. A non-transitory computer-readable storage medium comprising instructions to cause processing circuitry of a device for gap management of gap management for packet data convergence protocol or radio link control count, upon execution of the instructions by the processing circuitry, to:
decode an indication, received from a first device, that the device is to skip a gap in a count of packets;
decode a first subset of the packets, wherein the first subset is received from the first device;
determine, based on the indication, that a second subset of the packets was not transmitted by the first device or is not to be decoded by the device; and
update a count of the device to skip the second subset prior to expiration of a reordering timer of the device.

14. The non-transitory computer-readable medium of claim 13, wherein execution of the instructions further causes the processing circuitry to update a packet data convergence protocol (PDCP) state variable based on the indication.

15. The non-transitory computer-readable medium of claim 13, wherein the first subset and the second subset comprise packet data convergence protocol (PDCP) data units.

16. The non-transitory computer-readable medium of claim 13, wherein the device is a network nodeB (gNB).

17. The non-transitory computer-readable medium of claim 13, wherein the device is a user equipment (UE).

18. The non-transitory computer-readable medium of claim 13, wherein the indication comprises a bitmap.

19. The non-transitory computer-readable medium of claim 13, wherein the indication comprises a list of pairs of a start count and an end count, an offset, and a range.

20. (canceled)

21. (canceled)

22. (canceled)

23. A method for gap management of gap management for packet data convergence protocol or radio link control count, the method comprising:
encoding, by processing circuitry of a first device, a first subset of packets;
encoding, by the processing circuitry, a second subset of packets based on the first subset;
allocating, by the processing circuitry, a count for the first subset and the second subset;
detecting, by the processing circuitry, that the second subset is not to be transmitted by the first device or decoded by a second device; and
encoding, by the processing circuitry, based on detecting that the first subset is not to be transmitted by the first device or decoded by the second device, an indication to be transmitted to the second device to instruct the second device to skip a gap in the count based on the second subset.

24. (canceled)

25. (canceled)
